(19) United States
(12) Patent Application Publication
(10) Pub. No.: US 2006/0147254 A1
(43) Pub. Date: Jul. 6, 2006

(54) Lever for a ring mechanism

(75) Inventor: Hung Y. Cheng, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 11/157,620

(22) Filed: Jun. 21, 2005

Related U.S. Application Data
(63) Continuation-in-part of application No. 11/027,550, filed on Dec. 30, 2004.
(60) Provisional application No. 60/678,844, filed on May 6, 2005.

(51) Int. Cl. B42F 13/20

(52) U.S. Cl. 402/38

(57) ABSTRACT

A ring mechanism for retaining loose-leaf pages comprises a housing, hinge plates, and ring members. The housing supports the hinge plates for pivoting motion moving the ring members mounted thereon between an open position and a closed position. In the open position, the ring members are apart and pages can be added or removed from the ring members. In the closed position, the ring members are together and pages are retained by the ring members. The mechanism comprises an actuator for causing the pivoting motion of the hinge plates. In one aspect, the actuator includes an opening arm that causes the hinge plates to pivot to open the ring members. In another aspect, it includes closing arms that cause the hinge plates to pivot to close the ring members.

### CROSS-REFERENCE TO RELATED APPLICATIONS

This application claims the benefit of U.S. Provisional Application No. 60/678,844, filed May 6, 2005, and entitled A Lever For A Ring Mechanism, the entire disclosure of which is hereby incorporated by reference. This application is also a Continuation-In-Part of U.S. patent application Ser. No. 11/027,550, filed Dec. 30, 2004, and entitled Ring Binder Mechanism Spring Biased to a Locked Position when Ring Members Close, the entire disclosure of which is hereby incorporated by reference.

### BACKGROUND OF THE INVENTION

This invention relates to a ring mechanism for retaining loose-leaf pages, and in particular to an improved mechanism for opening and closing ring members.

A ring mechanism typically retains loose-leaf pages, such as hole-punched papers, in a file or notebook. An elongated housing loosely supports a pair of hinge plates joined together at a pivot axis for loose pivoting motion relative to the housing. Ring members are mounted on the hinge plates in opposing fashion for movement with the hinge plates between an open position and a closed position. The housing is generally narrower than the joined hinge plates when the hinge plates are in a coplanar position (180°). As the hinge plates pivot through the coplanar position, they deform the housing and cause a spring force urging them to pivot away from the coplanar position and either open or close the ring members. The housing spring force holds the closed ring members together and the open ring members apart. Variations of the conventional ring mechanism are known to those of ordinary skill in the art.

Closed ring members can be opened by pulling them apart, and open ring members can be closed by pushing them together. This overcomes the housing spring force and moves the hinge plates through the coplanar position. Opening and closing the ring members in this manner can be awkward, however, when the ring members are filled with pages. The ring members may be difficult to grasp and move between the closed and open positions.

Many ring mechanisms use levers to open and close the ring members. The levers are easier to grasp when ring members are filled with pages. But they often have a complex shape and are generally large and bulky in order to provide sufficient strength to repeatedly push or pull the hinge plates through their coplanar position. Accordingly, the levers may take up large amounts of room in the ring mechanisms, and housings of the mechanisms may need to be specially formed to accommodate the large levers.

Accordingly, there is a need for a ring mechanism having a lever operable to move ring members between an open and closed position where the lever is efficiently sized and strongly formed for repeat operation of the ring mechanism.

### SUMMARY OF THE INVENTION

A ring mechanism for retaining loose-leaf pages generally comprises a housing, hinge plates, rings for holding loose-leaf pages, and an actuator. The hinge plates are supported by the housing for pivoting motion relative to the housing. The rings each include a first ring member and a second ring member. The first ring member is mounted on a first hinge plate and is moveable with the pivoting motion of the first hinge plate relative to the second ring member between a closed position and an open position. In the closed position, the two ring members form a substantially continuous, closed loop for allowing loose-leaf pages retained by the rings to be moved along the rings from one ring member to the other. In the open position, the two ring members form a discontinuous, open loop for adding or removing loose-leaf pages from the rings. The actuator is mounted on the housing and is moveable relative to the housing. The actuator includes a longitudinal axis and at least two spaced apart arms. The arms are arranged to engage the hinge plates to pivot the hinge plates and move the ring members from one of their open and closed positions to the other of their open and closed positions.

In another aspect of the invention, a method of making an actuator for a ring mechanism generally comprises the steps of stamping an actuator blank from sheet material and bending the blank to form an arm. The arm is bent out of plane with the actuator blank and is capable of causing the hinge plates to pivot.

In still another aspect of the invention, the ring mechanism generally comprises a housing, hinge plates, rings, and an actuator. In this aspect of the invention, the hinge plates each have a thickness, and the actuator is mounted on the housing and moveable relative to the housing between a first position corresponding to the closed position of the ring members and a second position corresponding to the open position of the ring members. The actuator has a body and an arm, and the arm causes the hinge plates to pivot and move the ring members to their open position when the actuator moves from its first position to its second position. The body and arm of the actuator are formed as one piece from substantially thin, flat sheet material having a substantially uniform thickness. The arm has a major surface so that a plane containing the major surface of the arm is generally perpendicular to a plane containing the body.

Other features of the invention will be in part apparent and in part pointed out hereinafter.

### BRIEF DESCRIPTION OF THE DRAWINGS

FIG. 1 is a perspective of a ring mechanism of the invention mounted on a spine of a notebook;

FIG. 2 is a top side perspective of the ring mechanism at a closed and locked position;

FIG. 3 is a bottom side perspective thereof;

FIG. 4 is an exploded perspective of the ring mechanism;

FIG. 5 is an enlarged perspective of a lever of the mechanism;

FIG. 6 is an enlarged and fragmentary perspective of a rearward end of the ring mechanism with part of a housing broken away to show internal construction;

FIG. 7 is an enlarged and fragmentary longitudinal section of the rearward end of the ring mechanism;

FIG. 8 is a top side perspective of the ring mechanism at an open position;

FIG. 9 is a bottom side perspective thereof;

FIG. 10 is a view similar to FIG. 6 with the ring mechanism at the open position; and

FIG. 11 is a view similar to FIG. 7 with the mechanism at the open position.

Corresponding reference characters indicate corresponding parts throughout the drawings.

### DETAILED DESCRIPTION

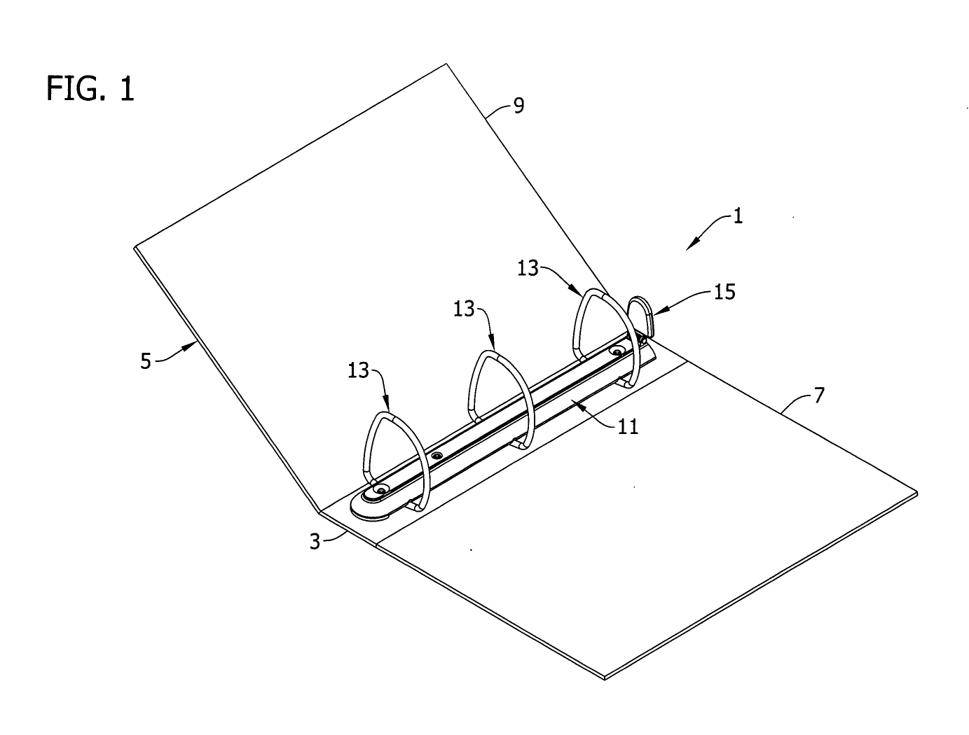

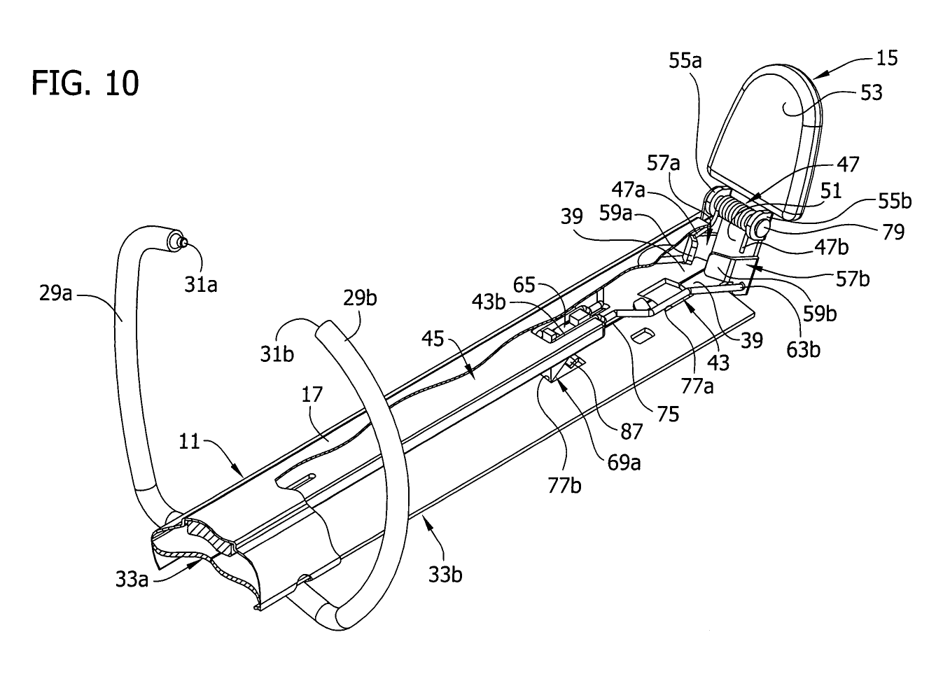

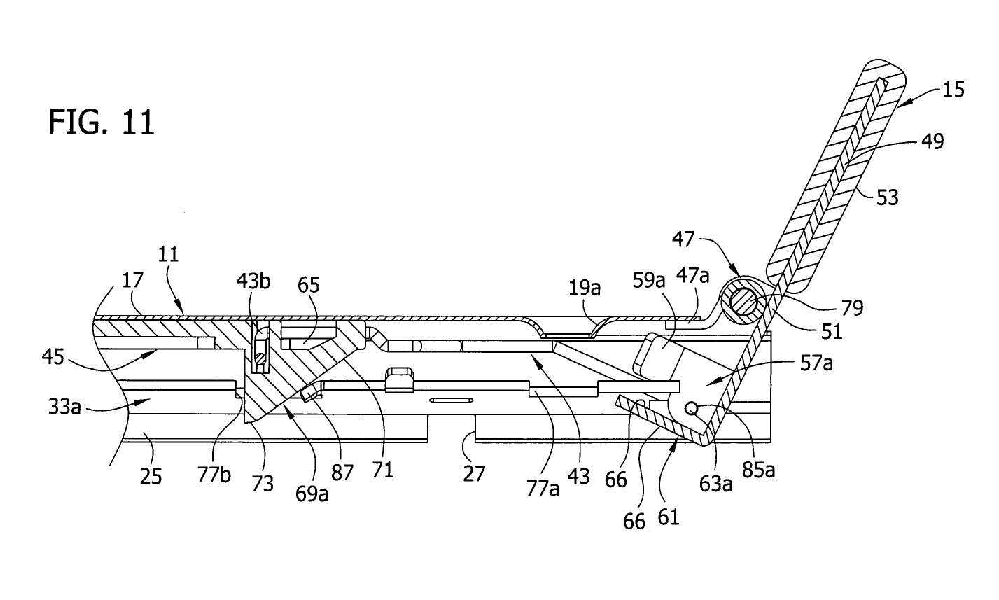

FIGS. 1-11 show a ring mechanism of the invention generally at reference numeral 1. The mechanism is typically used for retaining loose-leaf pages (not shown in the drawings) in a file or notebook. In FIG. 1, mechanism 1 is illustrated mounted on a spine 3 of a notebook. The notebook is indicated generally at reference numeral 5 and has a front cover 7 and a back cover 9 hingedly attached to the spine. Front and back covers 7, 9 move to selectively cover or expose pages retained by mechanism 1. A ring mechanism mounted on a surface other than a notebook, for example a file, does not depart from the scope of this invention.

As illustrated, mechanism 1 includes a housing, indicated generally at reference numeral 11, and three identical rings, each indicated generally at reference numeral 13. A lever (broadly, “an actuator”) is designated generally by reference numeral 15 and is shown pivotally mounted on a rearward longitudinal end of housing 11. As will be described in greater detail hereinafter, lever 15 uniquely operates to move rings 13 between a closed and locked position and an open position so that pages may be added, removed, or retained by mechanism 1. A mechanism having a lever at both ends of a housing or having an actuator other than a lever (e.g., a push button) is still within the scope of this invention.

The terms “forward” and “rearward” are used herein for convenience to describe relative orientation of components of the ring mechanism 1 of the invention. “Forward” refers to a direction away from the lever 15 (e.g., toward the left in FIG. 1) and “rearward” refers to a direction toward the lever (e.g., toward the right in FIG. 1). These terms do not limit the invention in any way.

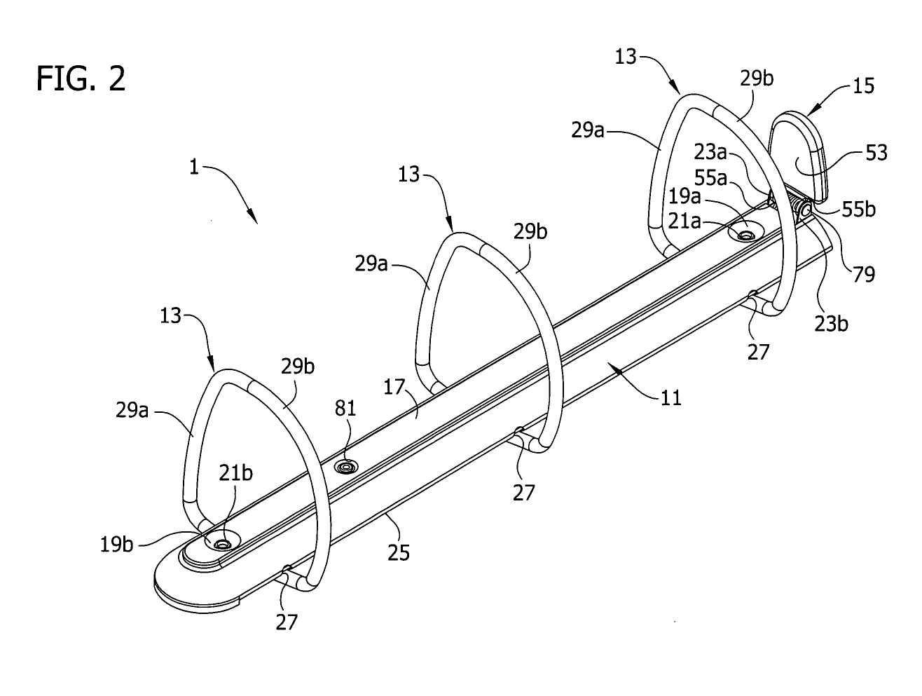

Referring to FIGS. 2-4, it can be seen that housing 11 is elongate with a uniform, generally arch-shaped cross section having at its center a raised plateau 17. Two mounting post openings 19a, 19b are located toward longitudinal ends of plateau 17 to receive and attach mounting posts 21a, 21b, respectively, to housing 11. Mounting posts 21a, 21b secure mechanism 1 to notebook 5 as shown in FIG. 1. The rearward end of housing 11, where lever 15 is mounted, is generally open and includes two identical mounting tabs 23a, 23b projecting upward from plateau 17. An opposite, forward longitudinal end of hosing 11 is rounded and generally closed. Bent under rims (each designated by reference numeral 25) are formed along both longitudinal edges of housing 11, and three openings (each designated by reference numeral 27) are formed in each of rims 25 at uniform longitudinal distances along the housing. A ring mechanism having a housing with a different shape, including an irregular shape, or a housing integral with a file or notebook does not depart from the scope of this invention.

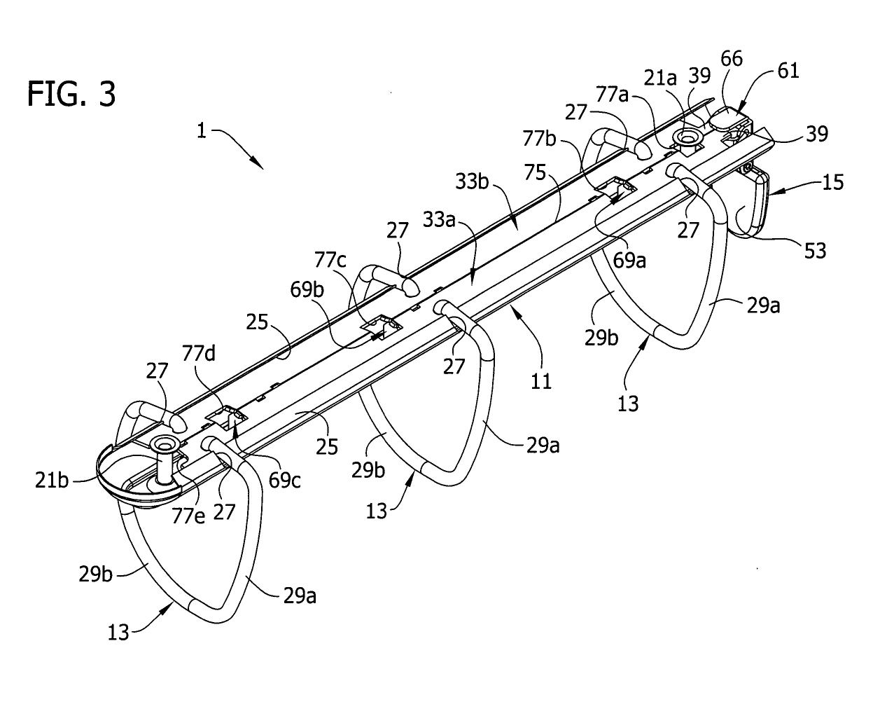

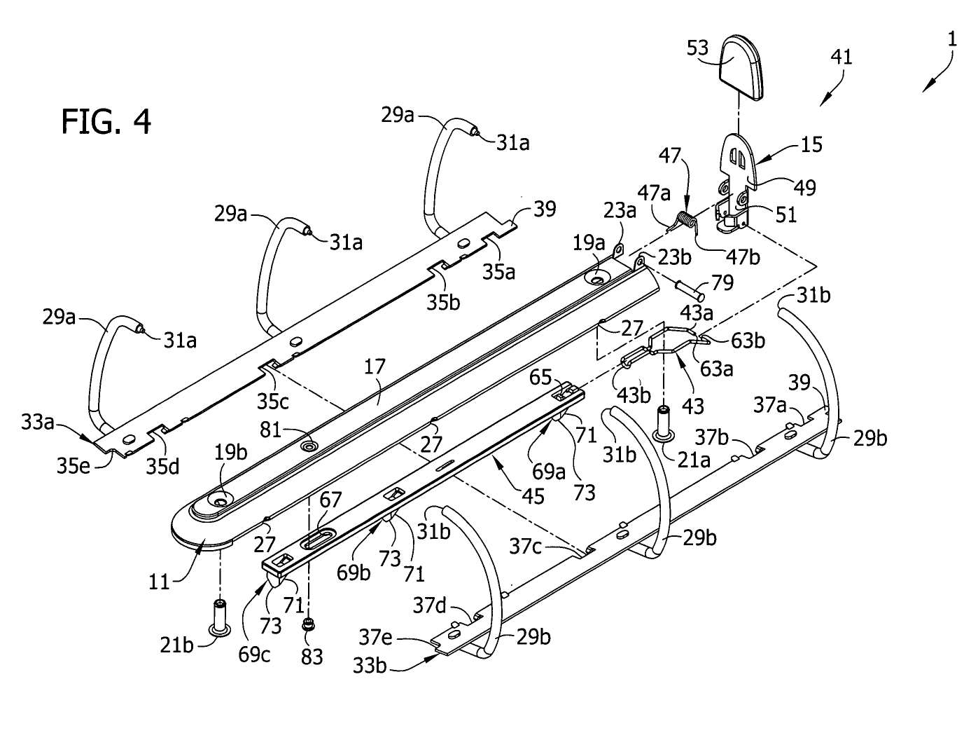

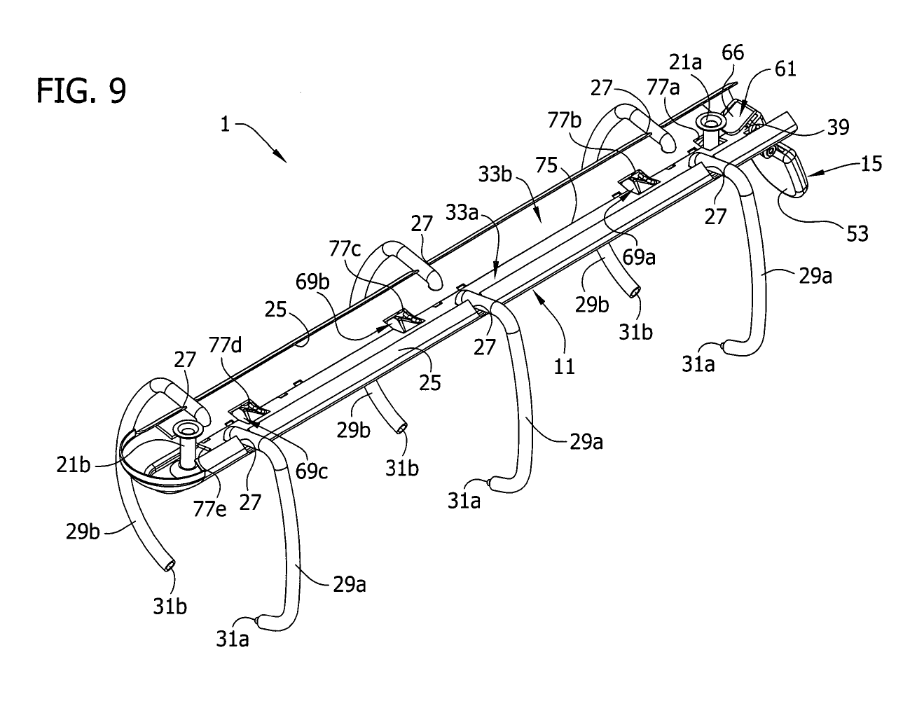

As best shown in FIG. 4, rings 13 supported by housing 11 each include a pair of mating ring members designated by reference numerals 29a, 29b. Both ring members have a roughly semi-circular, C-shaped profile. It is envisioned that ring members 29a, 29b are formed from a conventional, cylindrical rod of a suitable material such as steel, but ring members having different cross-sections or formed from different materials do not depart from the scope of the invention. Free ends 31a, 31b of respective ring members 29a, 29b are formed with mating structure that securely holds the ring members together against misalignment when they close (e.g., FIGS. 2 and 3). In illustrated mechanism 1, free end 31a is formed as a convex projection and free end 31b is formed as a concave bore (e.g., FIG. 9) sized to receive the convex projection. It is understood that a ring mechanism with ring members having different free end mating structures to securely hold closed ring members together (or even no mating structure) does not depart from the scope of the invention.

Ring members 29a, 29b are shown in FIG. 4 mounted on a bottom side of one of two mirror image hinge plates, designated generally at 33a, 33b. Suitable means known in the art are used to mount ring members 29a, 29b on hinge plates 33a, 33b. Each hinge plate is thin and elongate and generally rectangular in shape. Each includes five cutouts along respective inner edge margins. Cutouts in hinge plate 33a are designated by reference numerals 35a-e, and cutouts in hinge plate 33b are designated by reference numerals 37a-e. Cutouts 35a, 35e and 37a, 37e of respective hinge plates 33a, 33b are located toward opposite longitudinal ends of the plates while cutouts 35b-d and 37b-d are located inward and between end cutouts 35a, 35e and 37a, 37e, respectively. A finger 39 extends longitudinally away from a rearward end of each of hinge plates 33a, 33b at a location generally adjacent respective cutouts 35a, 37a. Each finger 39 is somewhat narrower than its respective hinge plate 33a, 33b, and an inner edge margin of each finger 39 aligns with the inner edge margin of its respective hinge plate. The purposes of cutouts 35a-e, 37a-e and fingers 39 will be described hereinafter.

Also shown in FIG. 4 is a control structure of mechanism 1. The control structure is designated generally by reference numeral 41 and is used to operate ring members 29a, 29b between their closed and locked position and their open position. Control structure 41 includes lever 15, an intermediate connector designated generally by reference numeral 43, a travel bar designated generally by reference numeral 45, and a torsion spring designated generally by reference numeral 47. Intermediate connector 43 joins lever 15 to travel bar 45 for movement therewith, and lever 15 pivots hinge plates 33a, 33b to open and close ring members 29a, 29b. Torsion spring 47 acts on lever 15 to automatically move travel bar 45 to a locked position when ring members 29a, 29b close. This operation will be described in more detail hereinafter.

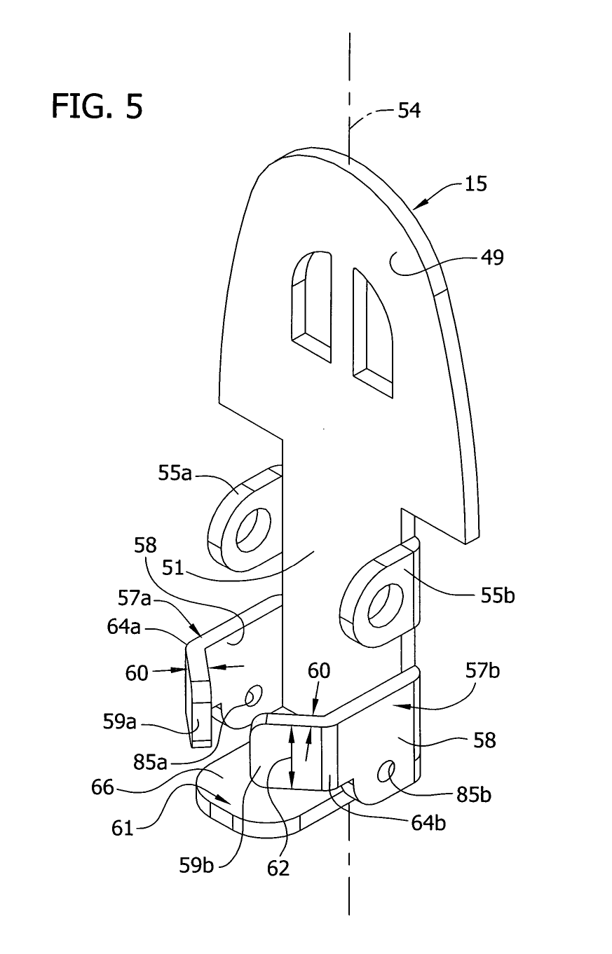

Lever 15 is best shown in FIG. 5. It includes an enlarged mushroom-shaped head 49 and a narrow stem-shaped body 51. A longitudinal axis of lever 15 is indicated by reference numeral 54. Head 49 and body 51 are both generally flat and lie in a common plane, with the head extending longitudinally away from a top end of the body. In illustrated mechanism 1, head 51 is integral with body 49. But they may be formed separately and attached together within the scope of the invention.

Lever 15 includes two identical and spaced apart mounting tabs 55a, 55b for mounting the lever on housing 11. The mounting tabs extend forward from opposite lateral sides of body 51 near where head 49 meets the body. Two mirror image and spaced apart closing arms, designated generally by reference numerals 57a, 57b, similarly extend forward from the opposite lateral sides of body 51 below respective mounting tabs 55a, 55b. The closing arms 57a, 57b each have major surfaces 58. Planes containing the major surfaces 58 are oriented generally perpendicular to the common plane containing head 49 and body 51. Closing arms 57a, 57b each have narrowed ends 59a, 59b, respectively, that bend inward and generally toward each other at bends 64a, 64b. The narrowed ends 59a, 59b are bent out of plane with the major surfaces 58 of respective closing arms 57a, 57b. The bends are generally parallel to the lever's longitudinal axis 54. Narrowed ends 59a, 59b each have a thickness dimension 60 and a height dimension 62 (only shown for end 59b) bigger than the thickness dimension to reinforce closing arms 57a, 57b against bending along an axis perpendicular to the longitudinal axis 54 of the lever 15. For each arm 57a, 57b, height dimension 62 is generally parallel to longitudinal axis 54 and generally transverse to thickness dimension 60. A flat opening arm 61 is located below closing arms 57a, 57b at a bottom end of body 51. Opening arm 61 includes major surfaces 66. Planes containing major surfaces 66 are oriented generally perpendicular to the common plane containing head 49 and body 51. In addition, the planes containing major surfaces 66 are oriented generally perpendicular to the planes containing major surfaces 58 of closing arms 57a, 57b. A thickness of opening arm 61 is about equal to a thickness of each of hinge plates 33a, 33b. Opening arm 61 extends forward from body 51 at about a 90° orientation with the body and is positioned in spaced apart, opposed relation with closing arm ends 59a, 59b. As can be seen, a space is formed between the opening arm 61 and closing arm ends 59a, 59b in which hinge plate fingers 39 can be received. This will be described in further detail hereinafter.

It is envisioned that lever 15 is formed by stamping a blank from sheet material. The stamped blank would include the lever head 49, body 51, mounting tabs 55a, 55b, closing arms 57a, 57b, and opening arm 61 all initially located in a common plane. The mounting tabs 55a, 55b, closing arms 57a, 57b, and opening arm 61 would then be bent out of plane with the head 49 and body 51 to form the lever 15. Free ends of closing arms 57a, 57b would be bent again, generally inward toward each other, out of plane with the major surfaces 58 of respective closing arms 57a, 57b to form the narrowed ends 59a, 59b, respectively. It is further envisioned that the sheet material used to form the lever 15 would have about the same thickness as the hinge plates 33a, 33b. Thus, it would be possible to form the lever 15 from the same material as the hinge plates 33a, 33b, potentially reducing production costs of the ring mechanism 1.

Referring again to FIG. 4, a lever cover 53 is provided to fit over head 49 of lever 15 to facilitate gripping and applying force to the lever during operation. It is envisioned that cover 53 is formed from a plastic or rubber material, but may be formed from any acceptable material within the scope of the invention. The intermediate connector 43 shown in FIG. 4 is illustrated as a wire bent into an elongate, generally rectangular form having a rearward open end 43a and a forward closed end 43b. Open end 43a angles slightly downward from closed end 43b and includes free ends 63a, 63b bent inward toward each other. Closed end 43b is narrower than open end 43a and is looped downward into a hook-shape. An intermediate connector (not shown) may have a different construction within the scope of this invention.

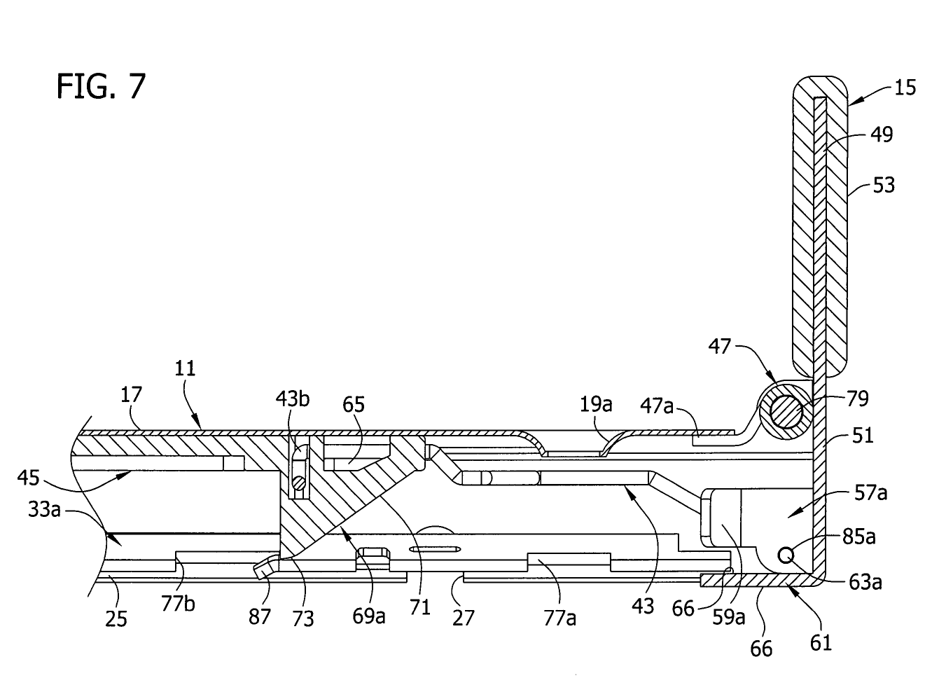

Travel bar 45 is elongate and relatively flat in shape. It includes a connector mount 65 toward a rearward longitudinal end and an elongated mounting channel 67 toward a forward longitudinal end. It also includes three locking elements longitudinally spaced along its underside. The locking elements are designated generally by reference numerals 69a-c. Forward surfaces 71 of the locking elements 69a-c are angled away from lever 15 and give each locking element a generally triangular longitudinal section (see, FIG. 7), and a transverse bottom edge 73 of each locking element 69a-c is generally rounded. It is envisioned that travel bar 45 and locking elements 69a-c are formed together as one piece by an injection mold process. However, a travel bar and locking elements formed by a different process or formed separate from each other are within the scope of the invention. A travel bar with more than or fewer than three locking elements or with locking elements shaped differently than described and illustrated herein is also within the scope of this invention.

Coiled torsion spring 47 (also known as a shank spring) is shown in FIG. 4 adjacent lever 15. It is a wire coiled into a spring form having free ends 47a, 47b extending away from the spring substantially at right angles relative to each other. Other spring forms can be used within the scope of this invention. Examples of other spring forms are shown in co-owned U.S. Pat. No. 11/027,550, which has been incorporated by reference.

The assembled ring mechanism 1 will now be described with reference to FIGS. 2, 3, 6, and 7. Mechanism 1 is shown in the closed and locked position in these figures. Referring first to FIGS. 2 and 3, hinge plates 33a, 33b are shown joined together in parallel arrangement along their inner longitudinal edge margins, forming a central pivoting hinge 75. Cutouts 35a-e and 37a-e in respective hinge plates 33a, 33b (FIG. 4) align to form cutout openings 77a-e, with hinge 75 symmetrically extending through each opening. The interconnected hinge plates fit under housing 11 with their outer longitudinal edge margins loosely supported behind each housing bent under rim 25, free to move within each rim when the hinge plates pivot upward and downward during operation. Mounting posts 21a, 21b secured to housing 11 at mounting post openings 19a, 19b extend downward from the housing through hinge plate cutout openings 77a, 77e, respectively, allowing hinge plates 33a, 33b to pivot relative to the mounting posts without contacting them. Ring members 29a, 29b mounted under hinge plates 33a, 33b extend away from the plates through one of openings 27 in the bent under rims 25 of the housing 11. The ring members can thus move relative to housing 11 with the pivoting motion the hinge plates 33a, 33b without contacting the housing.

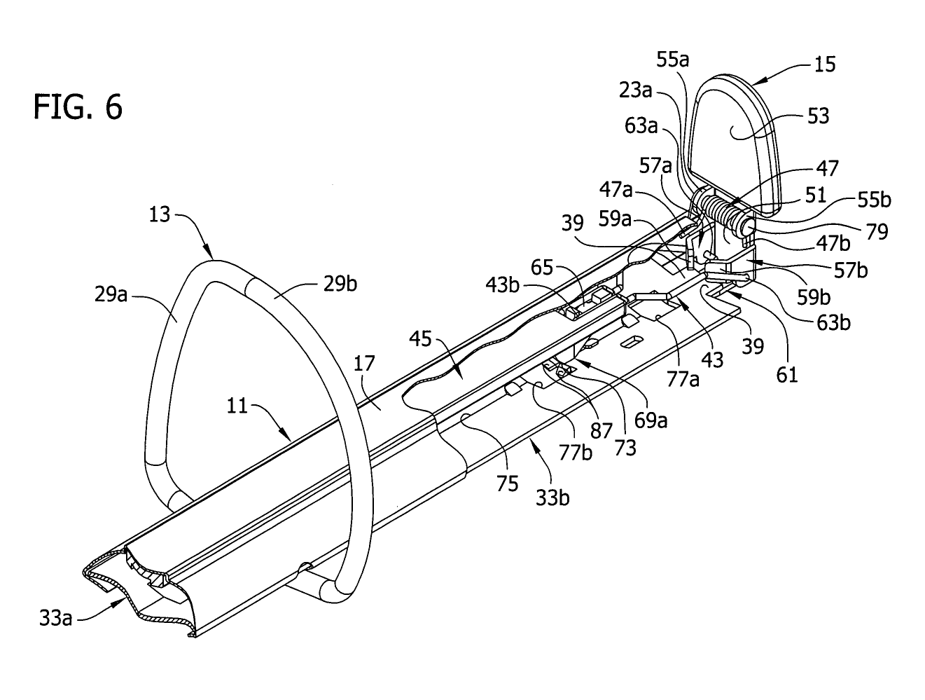

Referring now to the fragmentary views of mechanism 1 in FIGS. 6 and 7, fingers 39 of hinge plates 33a, 33b extend from the rearward ends of the plates toward lever 15 and into the space between opening arm 61 and closing arm ends 59a, 59b of the lever. Free ends 63a, 63b of intermediate connector 43 pivotally fit in openings 85a, 85b (FIG. 5) of lever closing arms 57a, 57b, and loop-shaped end 43b secures to travel bar connector mount 65. The connection between intermediate connector 43 and travel bar 45 is secure enough for the intermediate connector to push travel bar 45 away from lever 15 or pull it toward the lever, but still loose enough to allow the connector to pivot relative to the travel bar to accommodate small amounts of vertical movement of the connector occurring when the lever pivots and moves the connector. The form of connector 43 extends around mounting post 21a (FIG. 4) so that the connector can move relative to the post without contacting it during operation. This efficiently transmits pivoting movement of lever 15 around mounting post 21a to travel bar 45. A ring mechanism without an intermediate connector, for example one in which a travel bar is pivotally connected directly to a lever, or a mechanism with an intermediate connector shaped differently does not depart from the scope of this invention.

Travel bar 45 is shown in FIGS. 6 and 7 disposed behind plateau 17 of housing 11, generally parallel to the housing. Locking elements 69a-c (only locking element 69a is shown) are positioned between travel bar 45 and hinge plates 33a, 33b adjacent respective cutout openings 77b-d (only cutout opening 77b is shown). With reference again to FIG. 4, elongate mounting channel 67 of travel bar 45 aligns with inward mounting opening 81 of housing plateau 17. Grooved mounting rivet 83 secures to opening 81 and extends through channel 67, slidably securing travel bar 45 to housing 11 under plateau 17.

Again referring to FIGS. 6 and 7, lever 15 is mounted on housing 11 at housing mounting tabs 23a, 23b (FIG. 4). Mounting tabs 55a, 55b of lever 15 align with tabs 23a, 23b so that hinge pin 79 can extend through openings of the aligned tabs to pivotally secure the lever on housing 11. Torsion spring 47 connects to actuator 15 at hinge pin 79. The spring is located between lever mounting tabs 55a, 55b and extends substantially the full length of hinge pin 79 from one lateral side of lever body 51 to the other lateral side (e.g., coils of torsion spring 47 extend between the lever mounting tabs substantially the full length of the hinge pin from one lateral side of the lever body to the other lateral side of the lever body). Free end 47b of torsion spring 47 engages lever body 51 adjacent closing arm 57b, and free end 47a engages housing 11 under plateau 17.

Operation of ring mechanism 1 will now be described. FIGS. 1-3, 6, and 7 illustrate mechanism 1 in the closed and locked position. Ring members 29a, 29b of each ring 13 form a continuous, D-shaped loop for retaining loose-leaf pages. As best shown in FIGS. 3, 6, and 7, hinge plates 33a, 33b are hinged downward, away from housing 11, and lever 15 is vertical. Here, housing 11 provides a small spring force to hold hinge plates 33a, 33b pivoted downward. Locking elements 69a-c and travel bar 45 are positioned between hinge plates 33a, 33b and housing 11. The locking elements are out of registration with hinge plate cutout openings 77a-c and in line with hinge 75. Rounded bottom edges 73 of locking elements 69a-c contact upper surfaces of hinge plates 33a, 33b and, together with travel bar 45, firmly oppose any force tending to pivot the hinge plates to open the ring members 29a, 29b (i.e., lock the ring members closed).

To unlock mechanism 1 and open ring members 29a, 29b, lever 15 is pivoted outward and downward. This pushes intermediate connector 43 away from lever 15, which in turn pushes travel bar 45 and moves locking elements 69a-c into registration over hinge plate cutout openings 77a-c. Lever opening arm 61 is spaced below hinge plate fingers 39 and pivots into engagement with the fingers along hinge 75, initiating pivoting movement of plates 33a, 33b upward. The hinge plates deform housing 11 and produce the housing spring force that biases the hinge plates 33a, 33b away from their coplanar position. Once opening arm 61 pushes hinge plates 33a, 33b just through the coplanar position, the housing spring force moves them to their upwardly hinged position. Hinge plate cutout openings 77a-c pass over respective locking elements 69a-c without engaging them and ring members 29a, 29b open.

During this opening operation, free end 47b of torsion spring 47 moves with lever 15 toward free end 47a. This produces a tension in spring 47 resisting the lever's movement. If lever 15 is released before ring members 29a, 29b open, torsion spring 47 automatically urges lever 15 back to its vertical position, which pulls travel bar 45 and locking elements 69a-c back to their locked position.

Also during this opening operation, opening arm 61 of lever 15 is initially spaced apart from hinge plate fingers 39 when ring members 29a, 29b are closed and locked. When lever 15 moves to open ring members 29a, 29b, travel bar 45 and locking elements 69a-c move immediately and prior to opening arm 61 engaging and pivoting hinge plates 33a, 33b. This lost motion allows locking elements 69a-c to move into registration over respective hinge plate cutout openings 77a-c before hinge plates 33a, 33c pivot upward. Accordingly, locking elements 69a-c do not impede the desirable pivoting movement of hinge plates 33a, 33c to open ring members 29a, 29b. It is only after locking elements 69a-c register over respective openings 77a-c that opening arm 61 pushes the hinge plates upward.

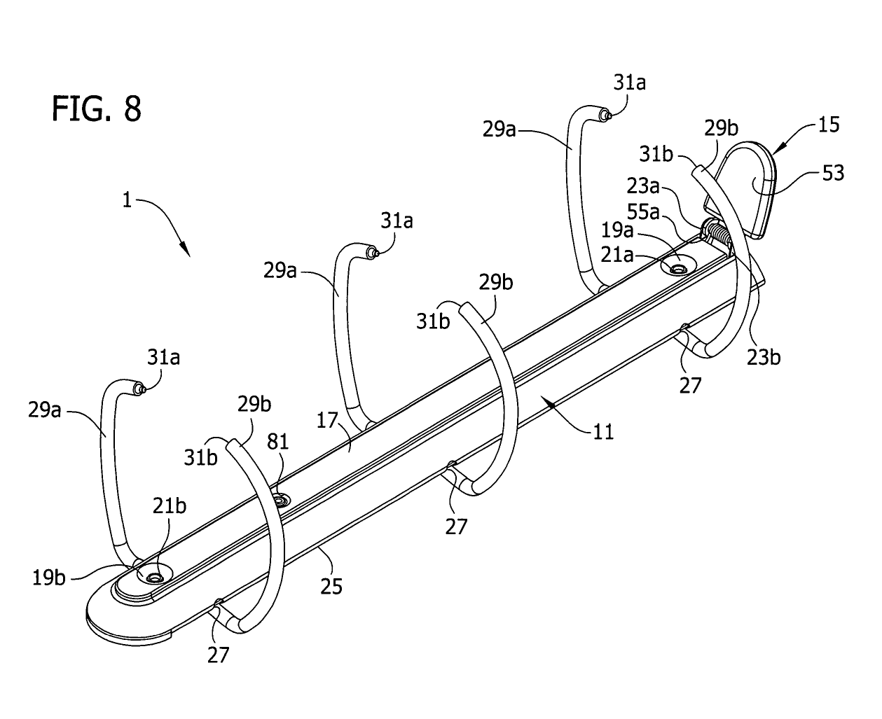

Once ring members 29a, 29b are open and lever 15 is released (FIGS. 8-11), the tension in torsion spring 47 recoils and slightly pushes on body 51 of lever 15. This pulls travel bar 45 and locking elements 69a-c toward lever 15 and moves the locking elements into engagement with angled tangs 87 of respective hinge plate cutout openings 77a-c. This also moves lever closing arm ends 59a, 59b into engagement with upper surfaces of hinge plates 33a, 33b. But this does not pivot hinge plates 33a, 33b downward (via locking elements 69a-c and closing arms 57a, 57b). The tension from torsion spring 47 is not strong enough to overcome the spring force of housing 11 holding hinge plates 33a, 33b pivoted upward. Ring members 29a, 29b are held open for adding or removing pages.

To close ring members 29a, 29b and lock mechanism 1, lever 15 can be pivoted upward and inward or ring members 29a, 29b can be pushed together. Pivoting lever 15 causes lever closing arms 57a, 57b to engage respective hinge plates 33a, 33b and push them downward, and causes intermediate connector 43 to pull travel bar 45 and locking elements 69a-c toward the lever. Angled surfaces 71 of locking elements 69a-c are shaped to allow hinge plates 33a, 33b to pivot downward without significantly engaging the locking elements (i.e., the angled surfaces allow for conjoint movement of the locking elements toward lever 15 and the hinge plates downward). As hinge plates 33a, 33b pass through their coplanar position, they deform housing 11 and the housing spring force drives them to their downwardly hinged position. Hinge plate tangs 87 pivot past locking element bottom edges 73, and the tension from torsion spring 47 pivots the lever 15 to its vertical position. This pulls travel bar 45 and locking elements 69a-c to their locked position with the locking elements behind the hinge plates.

Pushing ring members 29a, 29b together to close them directly pivots hinge plates 33a, 33b downward. Hinge plate fingers 39 engage lever opening arm 61 and pivot lever 15 upward and inward. This pulls intermediate connector 43 toward lever 15 and moves travel bar 45 and locking elements 69a-c therewith. The angled shape of locking elements 69a-c again prevents them from significantly contacting pivoting hinge plates 33a, 33b and allows the plates to pass through their coplanar position to their downwardly hinged position, clear of locking element bottom edges 73. Torsion spring 47 immediately pivots lever 15 to its vertical position, which pulls travel bar 45 and locking elements 69a-c to the locked position.

The several benefits of the invention should now be apparent. The lever uniquely includes two spaced apart closing arms and a flat opening arm for pivoting hinge plates to open and close ring members. In illustrated ring mechanism 1, closing arms 57a, 57b are taller than they are wide and are vertically spaced apart. Narrowed ends 59a, 59b engage hinge plates 33a, 33b with height dimensions 62 generally transverse to planes containing the hinge plates. This gives closing arms 57a, 57b additional and improved strength for pivoting hinge plates 33a, 33b through their coplanar position. This also provides increased vertical spacing between arms 57a and 57b, leaving extra room for locating torsion spring 47 therebetween. In prior art mechanisms having levers with closing arms, the arms are typically unitary structures extending the full width of the levers. The closing arms can significantly impede locating springs adjacent the levers for directly biasing the levers to pivot to lock the mechanisms closed.

Closing arms 57a, 57b also include narrowed ends 59a, 59b that bend inward toward each other. The narrowed ends engage fingers 39 of hinge plates 33a, 33b adjacent hinge 75 of the hinge plates. Accordingly, less force is required to move hinge 75 upward or downward and push hinge plates 33a, 33b through their co-planar position.

Opening arm 61 of mechanism 1 is substantially flat and does not significantly extend below bent under rims 25 of housing 11 (FIG. 7). Mechanism 1 can therefore be mounted on a notebook using short mounting posts without concern of the notebook interfering with pivoting movement of lever 15. In prior art mechanisms having levers with opening arms, the arms are typically large and bulky and extend below bent under rims of the mechanisms. Long mounting posts must be used to mount the mechanisms on notebooks to provide room for the levers to operate. But longer mounting posts provide less stability to the mounted ring mechanisms; short mounting posts are preferred.

It is understood that components of ring mechanism 1 are made of a suitable rigid material, such as a metal (e.g., steel). Mechanisms with components made of non-metallic materials, specifically including a plastic, do not depart from the scope of this invention. It is also understood that tabs 55a, 55b and arms 57a, 57b, 61 of lever 15 and tabs 23a, 23b of housing 11 may be integral with the lever and housing, respectively, or attached separately without changing the scope of the invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up”, “down”, “forward”, “rearward” and variations of these terms is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense. For example, although in illustrated ring mechanism 1 both ring members 29a, 29b of each ring 13 are mounted on hinge plates 33a, 33b and move with the pivoting movement of the hinge plates, a mechanism in which each ring has one movable ring member and one fixed ring member does not depart from the scope of this invention (e.g., a mechanism in which only one of the ring members of each ring is mounted on a hinge plate with the other ring member mounted, for example, on a housing). Also, ring members could be mounted on upper surfaces of hinge plates or could form a circular shape when closed without affecting the scope of the invention. Furthermore, more than or fewer than three rings could be incorporated into a ring mechanism within the scope of the invention.

What is claimed is:

1. A ring mechanism for retaining loose-leaf pages, the mechanism comprising:
a housing;
hinge plates supported by the housing for pivoting motion relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings; and
an actuator mounted on the housing and moveable relative to the housing, the actuator having a longitudinal axis and at least two spaced apart arms, the arms being arranged to engage the hinge plates to pivot the hinge plates for moving the ring members from one of their open and closed positions to the other of their open and closed positions.

2. A ring mechanism as set forth in claim 1 wherein the arms of the actuator each have a height dimension substantially parallel to the longitudinal axis of the actuator and a thickness dimension substantially perpendicular to the longitudinal axis of the actuator, the height dimension being larger than the thickness dimension.

3. A ring mechanism as set forth in claim 2 wherein the height dimension of each arm is oriented generally orthogonally to the hinge plates when the actuator moves to pivot the hinge plates and close the ring members.

4. A ring mechanism as set forth in claim 1 wherein the actuator comprises two arms for causing the hinge plates to pivot and move the ring members to their closed position, each arm including an end section bent out of plane with the rest of the arm at a bend, each bent end section being substantially parallel to the longitudinal axis of the actuator.

5. A ring mechanism as set forth in claim 1 wherein the hinge plates include fingers extending longitudinally away from ends of the hinge plates, the arms of the actuator engaging the fingers when the actuator causes the hinge plates to pivot to move the ring members to their closed position.

6. A ring mechanism as set forth in claim 1 further comprising a travel bar and a locking element connected to the travel bar, the travel bar being disposed between the housing and the hinge plates and being operatively connected to the actuator, the travel bar and locking element blocking the hinge plates from pivoting in the first position of the actuator.

7. A ring mechanism as set forth in claim 6 further comprising an intermediate connector connecting the actuator to the travel bar, the intermediate connector being separate from the actuator and travel bar and being connected to the actuator at one of the arms of the actuator.

8. A ring mechanism as set forth in claim 1 wherein the actuator further includes an opening arm for causing the hinge plates to pivot and move the ring members to their open position, the opening arm being separate from the arms that cause the hinge plates to pivot and move the rings to their closed position.

9. A ring mechanism as set forth in claim 1 further comprising a spring operatively connected to the actuator, the spring being oriented to urge the actuator to pivot from its second position to its first position.

10. A ring mechanism as set forth in claim 9 wherein the spring includes coils, the spring coils extending substantially from one lateral side of the lever to the other lateral side of the lever.

11. A ring mechanism as set forth in claim 1 in combination with a cover, the ring mechanism being mounted on the cover, the cover being hinged for movement to selectively cover and expose loose-leaf pages retained on the ring mechanism.

12. A method of making an actuator for a ring mechanism that retains loose-leaf pages, the ring mechanism comprising a housing, hinge plates supported by the housing for pivoting movement relative to the housing, and rings mounted on the hinge plates for movement with the hinge plates between an open position and a closed position, the method of making the actuator comprising:
stamping an actuator blank from sheet material;
bending the actuator blank to form an arm, the arm being bent out of plane with the actuator blank and being capable of causing the hinge plates to pivot.

13. A method of making an actuator as set forth in claim 12 wherein the arm includes a major surface, the arm being bent so that a plane containing said major surface of the arm is generally perpendicular to the plane containing the actuator blank.

14. A method of making an actuator as set forth in claim 13 wherein the arm causes the hinge plates to pivot to open the ring members.

15. A method of making an actuator as set forth in claim 12 wherein bending the actuator blank comprises bending the actuator blank to form two arms each having a major surface and each being bent out of plane with the actuator blank, a plane containing the major surface of a first arm being generally parallel to a plane containing the major surface of the second arm, the planes containing the major surfaces of the first and second arms each being generally perpendicular to the plane containing the actuator blank.

16. A method of making an actuator as set forth in claim 15 wherein the first and second arms cause the hinge plates to pivot to close the ring members, the method further comprising bending the actuator blank to form a third arm bent out of plane with the actuator blank and having a major surface, a plane containing the major surface of the third arm being generally perpendicular to the plane containing the actuator blank and being generally perpendicular to the planes containing each of the major surfaces of the first and second arms.

17. A method of making an actuator as set forth in claim 15 further comprising a step of bending free ends of each of said two arms out of plane with the respective major surface of each arm.

18. A ring mechanism for retaining loose-leaf pages, the mechanism comprising:
a housing;
hinge plates each having a thickness, the hinge plates being supported by the housing for pivoting motion relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings; and
an actuator mounted on the housing and moveable relative to the housing between a first position corresponding to the closed position of the ring members and a second position corresponding to the open position of the ring members, the actuator having a body and an arm, the arm causing the hinge plates to pivot and move the ring members to their open position when the actuator moves from its first position to its second position;
the body and arm of the actuator being formed as one piece from substantially thin, flat sheet material having a substantially uniform thickness, the arm having a major surface so that a plane containing the major surface of the arm is generally perpendicular to a plane containing the body.

19. A ring mechanism as set forth in claim 18 wherein the thickness of the sheet material is about equal to the thickness of the hinge plates.

20. A ring mechanism as set forth in claim 18 wherein the major surface of the arm engages the hinge plates when the arm causes the hinge plates to pivot and move the ring members to their open position.

21. A ring mechanism as set forth in claim 18 wherein the actuator further includes two closing arms for causing the hinge plates to pivot and move the ring members to their closed position when the actuator moves from its second position to its first position, the closing arms being formed as one piece with the body and each having a major surface disposed in a plane generally perpendicular to a plane containing the body.
